(19) United States
(12) Patent Application Publication
(10) Pub. No.: US 2022/0253870 A1
(43) Pub. Date: Aug. 11, 2022

(54) BLOCKCHAIN NETWORK SUPPLIER VERIFICATION

(71) Applicant: RESEARCH BLOCKS TECHNOLOGIES, INC, Tampa, FL (US)

(72) Inventors: Christopher JONES, Tampa, FL (US); Lance CLEVELAND, Mt Pleasant, SC (US)

(21) Appl. No.: 17/668,707

(22) Filed: Feb. 10, 2022

Related U.S. Application Data
(60) Provisional application No. 63/147,992, filed on Feb. 10, 2021.

(51) Int. Cl. G06Q 30/00

(52) U.S. Cl. CPC G06Q 30/018

(57) ABSTRACT

An immutable and distributed system verifies and determines the degree to which material specifications set forth by manufacturers are met by material suppliers. Laboratory and quality control testing results for material specifications are logged by material suppliers on a blockchain network and are confirmed through retesting by a third-party testing laboratory or the manufacturer. Confirmation data are also logged on the blockchain network. The data are shared throughout the blockchain supply chain network and can either be reconfirmed by another third-party testing laboratory or manufacturer or taken that the supplier's lot of materials is verified and that the supplier is verified.

### TECHNICAL FIELD

Embodiments of the subject matter disclosed herein relate to immutable verification of materials and material suppliers.

### BACKGROUND

Currently, dietary supplement manufacturers are required to set quality specifications for incoming raw materials. These specifications include tests to account for the identity, purity, strength, composition, and acceptable level of contaminants that will be present or affect the finished dietary supplement product. Raw material suppliers must meet these set specifications for each lot and shipment of provided raw materials. Suppliers must provide documentation, known as a Certificate of Analysis (CoA), that these specifications were tested for and met.

Referring to FIG. 1, in a conventional raw material quality specification testing and verification system, a first supplement manufacturer 102, a second supplement manufacturer 104 and a third supplement manufacturer 106 communicate quality specifications for a desired raw material to a given raw material supplier 100. The raw material supplier tests the raw material, generates the CoA and ships the raw material to each manufacturer along with the CoA indicating that the quality specifications are met in the shipped batch of raw material. Upon receipt, each manufacturer must also verify that the quality specifications, set forth for their raw materials, were met by the supplier and the provided CoAs are accurate. This verification by the manufacturer can be done in-house, for example, by the first supplement manufacturer providing verification 110 and the second supplement manufacturer providing verification 112, or through third-party testing labs, for example by the third supplement manufacturer using a third-party testing lab 108 to provide verification 114.

Additionally, manufacturers have the option to “verify their suppliers” and, once verified, can rely on the supplier's Certificate of Analysis for the requirements set out in the raw material specifications for a set period of time. However, manufacturers must always test for the identity of the raw material and “verified” suppliers must be re-verified periodically. Therefore, testing is not completely eliminated, and verification is still required. In addition, the CoA's from the supplier and the verifications performed by each manufacturer are not shared. Because verification data are not shared among manufacturers, suppliers, and third-party labs, tests are repeated frequently, and suppliers are verified on a per manufacturer basis.

Therefore, the need still exists for an improved system and method for verifying suppliers and raw materials that facilities sharing of verification data from multiple suppliers, manufacturers and third-party testing laboratories in a secure, trusted and stable format that increases a degree of certainty associated with raw materials and raw material suppliers.

### SUMMARY

Exemplary embodiments are directed to a blockchain (immutable and distributed) system to verify and determine the degree to which material specifications set forth by manufacturers are met by material suppliers. As discussed herein, the material specifications are raw material specifications that are set forth by dietary supplement manufacturers and that are met by raw material suppliers. However, embodiments are not limited to dietary supplements, raw materials, raw material suppliers and dietary supplement manufacturers, but can cover any type of material that is supplied to another party for incorporation into or manufacture of another product including, for example, computing equipment, semiconductors, automobiles, furniture, medical equipment, and pharmaceuticals. Lab results for raw material specifications are logged manually or in real-time by raw material suppliers on a blockchain network. A third-party testing laboratory, a supplement manufacturer or combinations of third-party testing laboratories and supplement manufacturers confirm those results by retesting the criteria set forth in the specifications. This information is logged manually or in real-time by each party performing the testing, i.e., the third-party testing laboratory or supplement manufacturer, on the blockchain network. A collection of data processing rules embodied in code stored along with a current data state stored within the blockchain, for example an Ethereum-style smart contract, is used to ensure the results provided by the raw material supplier matches the results of the third-party testing laboratory or manufacturer. In general, a smart contract is a set of immutable rules defining how data stored on a blockchain can be interacted with along with the current state of the data. These rules, embodied in code, and the data state are stored in the blockchain.

Smart contract functions are employed to facilitate recording of verified lab results and ensuring they are associated with the supplier as well also to create and validate relationships with manufacturers. This information is shared throughout the blockchain supply chain network and can either be further reconfirmed by another third-party testing laboratory or supplement manufacturer or can be relied upon to show that the raw material supplier's lot of raw materials is verified and that the raw material supplier can be verified. In one embodiment, the information also provides a count of how many times a given lot of raw materials or a given supplier has been verified.

Exemplary embodiments are directed to a method for verifying materials and material suppliers by storing in an immutable database an initial set of material testing results generated by a first entity and analyzing a given lot of material for compliance with a quality specification for the material, storing in the immutable database in association with the initial set of material testing results at least one confirming set of material testing results generated by at least one additional entity separate from the first entity to confirm the initial set of material testing results, and using the initial set of material testing results and all confirming sets of material testing results to determine an overall degree of validation for the given lot of material. The immutable database maintains a trusted historical record of all material testing results for the given lot of material and for a given supplier across all lots of all material provided by the given material supplier. Therefore, both materials or components, lots of materials and material suppliers can be verified using the stored testing and validation data. Material testing results are stored in the immutable database with transparency to historical changes in material testing results. In one embodiment, the immutable database is a blockchain database.

In one embodiment, at least one of a unique unchangeable key for the initial set of material testing results, an identification of the material, an identification of a supplier of the material, an identification of a requestor of the material, and an identification of the first entity is stored in the immutable database for the initial set of material testing results. In one embodiment, at least one of a unique unchangeable key for each confirming set of material testing results, an identification of the material, an identification of a supplier of the material, an identification of a requestor of the material, and an identification of each additional entity is stored in the immutable database for each verification set of material testing results.

In one embodiment, processing rules governing interaction with material testing results stored in the immutable database to ensure matching of all material testing results for a given lot of material are storing in the immutable database in combination with a current data state of the material testing data of the data record associated with the material testing data or material supplier. In one embodiment, the data processing rules are a smart contract. In one embodiment, a permanent unique identification code is associated with the lot of material, a supplier of the lot of material and each entity generating material testing results. The associated permanent unique identification codes are used to index material testing results or to search material testing results. In one embodiment, the first entity is a supplier of the lot of material or an independent testing facility. In addition, each additional entity is an independent testing facility, a requester of the lot of material, another manufacturer, or a recipient of the lot of material.

In one embodiment, the initial set of material testing results and all confirming sets of material testing results are used to determine an overall degree of validation for the given lot of material by assigning one degree of validation to the lot of material for each confirming set of material testing results that confirm the initial set of material testing results. In one embodiment, the overall degree of validation is adjusted by only assigning a degree of validation for each confirming set of material testing results associated with testing performed within a prescribed time period, requiring a minimum number of confirming sets of material testing results that confirm the initial set of material testing results, setting a threshold ratio of confirming sets of material testing results that confirm the initial set of material testing results to confirming set of material testing results that fail to confirm the initial set of material testing results, and combinations thereof.

In one embodiment, a plurality of initial sets of material testing results for a plurality of lots of materials is stored in the immutable database. Each lot of material is supplied by a given material supplier. Therefore, each lot can be supplied by the same material supplier, or the plurality of lots can be supplied by two or more material suppliers. The at least one confirming set of material testing results is stored in the immutable database in association with one of the plurality of initial sets of material testing results. The plurality of initial sets of material testing results and all confirming sets of material testing results are used to determine an overall degree of validation for the given material supplier or each material supplier. In one embodiment, the plurality of initial sets of material testing results and all confirming sets of material testing results are used to determine a frequency at which all lots of material provided by the given material supplier are verified by the confirming sets of material testing results.

Exemplary embodiments are also directed to a material and supplier verification system comprising that includes an immutable database containing an initial set of material testing results generated by a first entity and analyzing a given lot of material for compliance with a quality specification for the material and at least one confirming set of material testing results generated by at least one additional entity separated from the first entity to confirm the initial set of material testing results, each confirming set of material testing results associated within the immutable database with the initial set of material testing results, and the immutable database maintaining a trusted historical record of all material testing results for the given lot of material. The system also includes a computing system in communication with the immutable database. The computing system executes and instance of a validation module that uses the initial set of material testing results and all confirming sets of material testing results to determine an overall degree of validation for the given lot of material. In one embodiment, the immutable database is a blockchain database. In one embodiment, the immutable database also at least one of a unique unchangeable key for the initial set of material testing results, an identification of the material, an identification of a supplier of the material, an identification of a requestor of the material, an identification of the first entity, and an identification of each additional entity.

In one embodiment, the verification module assigns one degree of validation to the lot of material for each confirming set of material testing results that confirm the initial set of material testing results. In addition, the verification module adjusts the overall degree of validation by only assigning a degree of validation for each confirming set of material testing results associated with testing performed within a prescribed time period, requiring a minimum number of confirming sets of material testing results that confirm the initial set of material testing results, setting a threshold ratio of confirming sets of material testing results that confirm the initial set of material testing results to confirming set of material testing results that fail to confirm the initial set of material testing results, and combinations thereof.

In one embodiment, the immutable database includes a plurality of initial sets of material testing results for a plurality of lots of materials. Each lot of material is supplied by a given material supplier. The at least one confirming set of material testing results is associated with each one of the plurality of initial sets of material testing results, and the verification module uses the plurality of initial sets of material testing results and all confirming sets of material testing results to determine an overall degree of validation for the given material supplier. In one embodiment, the verification module determines a frequency at which all lots of material provided by the given material supplier are verified by confirming sets of material testing results.

### FIGURES

FIG. 1 is a representation of a conventional environment for verification of raw materials and raw material suppliers by supplement manufacturers;

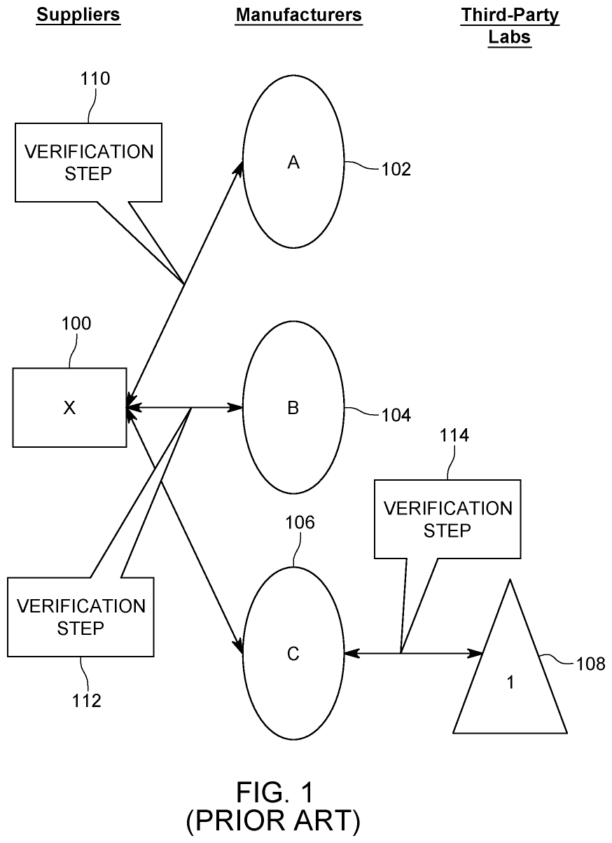

FIG. 2 is an illustration of an embodiment of a raw material supplier and supplement manufacturer system for requesting and delivering raw materials and verifying compliance with raw material specifications;

FIG. 3 is a flow chart illustrating an embodiment of a method for verifying materials and material suppliers;

FIG. 4 is a representation of an embodiment of an environment for verification of raw material and raw material suppliers using a supplier verification system that produces increased levels of verification; and

FIG. 5 is a representation of another embodiment of an environment for verification of raw material and raw material suppliers using a supplier verification system that produces increased levels of verification.

### DETAILED DESCRIPTION

Exemplary embodiments are directed to methods and systems for securely storing and sharing the results of material testing. These materials include, but are not limited to, materials, for example, raw materials, that are supplied by material suppliers and that are received and utilized by the recipients of those materials. In one embodiment, the materials are raw materials, and the suppliers of the materials are raw material suppliers. In general, suitable materials include, but are not limited to, liquids, chemicals, compounds, minerals, wood, metals, plastics, polymers, and components that are used in the manufacture or are incorporated into other devices and finished products. In general, the suppliers of the materials provide the materials in lots. The recipients of the materials can utilize the materials as-delivered, can incorporate the materials into other products, for example, mixtures or supplements, or can utilize the materials in the manufacture of finished products. In one embodiment, the recipients of the material is a manufacturer, for example, a supplement manufacturer, and the materials are raw materials. In one embodiment, the raw material is used to formulate or create a supplement such as a therapeutic or nutritional supplement.

Systems and method in accordance with exemplary embodiments provide for the secure storage and sharing of information relevant to the quality of the material in a given lot of material. The quality of the material is evaluated in accordance with material quality specifications that are determined or established by the requestor or recipient of the material. In general, these material quality specifications prescribed qualities and functions of the material or component that are important or relevant to the use and incorporation of that material into the finished product. These qualities will vary from product to product. Evaluation of a given lot of material in accordance with the material quality specification includes testing of the given lot of material. This testing is conducted by different entities including the supplier of the material, third-party or independent testing laboratories, the requestor of the material, and a recipient of the raw material.

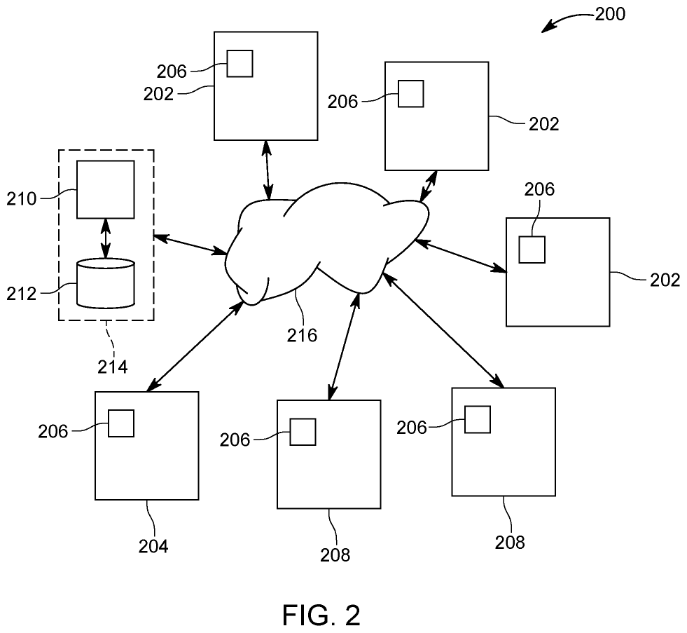

Referring initially to FIG. 2, an exemplary embodiment of a system 200 that can be used by a plurality of material suppliers, e.g., raw material suppliers, and a plurality of requestors and recipients of the supplied materials, e.g., supplement manufacturers is illustrated. The system 200 facilitates the identification of material quality specifications, the requesting of materials, the delivery of materials, the verification of supplied materials with the material quality specifications, and validation of the suppliers of the materials based on a history of material verifications for materials shipped or supplied by the suppliers. The system includes one or more requestors 202 of materials, e.g., raw materials. Suitable requestors include, but are not limited to, supplement manufacturers. Each requestor can provide quality specifications for one or more types of material, e.g., raw materials. These quality specifications can be the same across a given raw material. Alternatively, the material quality specifications vary from raw material to raw material, from requestor to requestor or from supplier to supplier. The system also includes one or more material suppliers 204, e.g., raw material suppliers. Each material supplier prepares one or more lots of the material and delivers each lot of the material to the material requestor or to other recipients such as other manufacturers. In addition to supplying one or more lots of materials, each material supplier tests each lot of material, or has each lot of material tested, for compliance with the appropriate material quality specification. In one embodiment, the CoA is generated and communicated to the appropriate recipient of the lot of material. In one embodiment, the system 200 includes a plurality of material requestors 202, e.g., supplement manufacturers and one or more independent or third-party testing laboratories 208.

The system also includes a material and supplier verification system 214. Each material supplier is in communication with the material and supplier verification system 214. In one embodiment, the material and supplier verification system includes at least one computing system 210. The computing system includes one or more logical processors which are used to executed computer-readable code. Through execution of the computer-readable code the computing system provides the desired functionality of modules for the material and supplier verification system. Suitable computing systems include servers, stand-alone computer systems and distributed computing systems. The material and supplier verification system includes one or more storage media or computer readable storage systems 212.

The material requesters 202, material suppliers 204 and independent testing laboratories 208 are in communication with the supplier verification system 214 across one or more local or wide area networks 216. In one embodiment, the material and supplier verification system includes a data collection tool 206 to input the testing results. The data collection tool 206 is provided at each material requester 202, material supplier 204 and independent testing laboratory 208, for example, on user equipment or other computing systems located at the material requester 202, material supplier 204 or independent testing laboratory 208. Each material requester 202, material supplier 204 and independent testing laboratory 208 utilizes the data collection system 206 to communicate material testing results, e.g., initial sets of material testing results and confirmation or verification sets of material testing results or data to the supplier verification system. The material testing results are the verification testing data generated to confirm compliance with the material quality specification, to confirm the testing data provided by the material supplier and to confirm the CoA provided by the material supplier. The data collection tool can be, for example, a spreadsheet into which the data is entered.

In one embodiment, the data collection tool is OmniBlocks®, which is commercially available from Research Blocks Technologies, Inc. Each instance of the data collection tool running at a material requester 202, a material supplier 204 or an independent testing laboratory 208 is in communication with the supplier verification system through one or more local or wide area networks 216. Therefore, material testing results are uploaded to the supplier verification system. In one embodiment, the computing system of the material and supplier verification system includes a secure communication module that can encrypt communications among the material requesters, material suppliers, independent testing laboratories and material supplier and verification system. In one embodiment, material testing results are encrypted by the secure communication module prior to being communicated from each instance of the data collection system to the supplier verification system. For example, the material testing results or data recorded in the data collection system and retrieved by the material and supplier verification system is secured using published blockchain or hyperledger cryptography, for example, the SHA-256 cryptographic hash function. This ensures that the material testing results or data are secure and can be trusted.

In one embodiment, the material and supplier verification system includes additional material supplier verification criteria. The additional material supplier verification criteria in combination with confirmation of the CoA provided by each material supplier provide full verification of each material supplier. The additional material supplier verification criteria utilize a few extra steps. The additional steps include, for each raw material or material supplier, completion of a current Goods Manufacturing Practices (cGMP) self-audit questionnaire, a virtual or in-person facility audit, and confirmation that cGMP practices are being followed and a Quality Management System (QMS) system is in place. Use of the data collection system, e.g., the OmniBlocks® platform, helps ensure material suppliers are following cGMP documentation and tracking practices set out by the specific Code of Federal Regulations (CFR). Additionally, the QMS modules provided by the OmniBlocks® system confirms an appropriate cGMP QMS system is being utilized. These features of OmniBlocks® further automate the process of material supplier verification, cut down the need for material requestors and material recipients to individually verify material suppliers and alleviate the burden of repeated testing within the supply chain.

To ensure immutable transparent transactions, the material and supplier verification system includes and maintains one or more industry standard databases on the storage systems. Suitable databases are immutable databases, for example, blockchain or hyperledger-style databases. Suitable immutable database on the storage systems include, but are not limited to, Amazon Quantum Ledger and Ethereum. These immutable databases are built on community standards and provide immutable data storage with transparency of historical changes, which can be validated using standard cryptographic techniques. The implementation allows for the creation of a trusted historical record of all transactions, e.g., material testing results or data supplied to the material and supplier verification through the data collection systems associated with the raw material suppliers, supplement manufacturers and independent or third-party testing laboratories. In addition to the material testing results, each transaction includes data such as a unique unchangeable key, an identification of the raw materials or lot of materials, an identification of the entity that performed the testing, an identification of the entity requesting the material, an identification of the entity requesting material testing by an independent testing laboratory, and an identification of the material supplier. Once recorded to the immutable database on the ledger or blockchain, the material testing results and additional data cannot be updated, deleted, or modified in any way.

In one embodiment, labels such as permanent unique identification (ID) codes are associated with each material supplier, each raw material or lot of material, each material requestor or material recipient, and each independent or third-party testing center. These permanent unique ID codes provide for data integrity and for organization and searching of the material testing data including the material supplier verification data. For example, Manufacturer A is assigned a permanent unique ID, M-2345, and this permanent unique ID is associated with every transaction related to that supplement manufacturer. Similarly, Raw Material 1 is assigned a permanent unique ID, R-3456, and this permanent unique ID is associated with every transaction related to the raw material. Raw material Supplier X is assigned a permanent unique ID, S-1234. Manufacturer A performs testing on Raw Material 1 supplied by Supplier X, and the results of the test, i.e., the material testing results, are recorded to the immutable database or storage medium, for example, Amazon Quantum Ledger, by the supplier verification system using standard API calls that record the key metrics such as the Supplier ID (S-1234), Manufacturer ID (M-2345), the Raw Material ID (R-3456), and the material testing results. In one embodiment, this record of the material testing results is assigned a unique locator ID, L-4567, which is returned from the storage requests.

The use of unique permanent identification codes provides for storage, indexing, and searching of the material testing results by material suppliers, supplement manufacturers, independent or third-party testing laboratories. Therefore, all interested entities looking for verification of a material or material supplier can easily locate relevant verification and validation data in the material and supplier verification system. For example, the material testing results locator ID L-4567 is related to Supplier X, Manufacturer A, and Raw Material 1 via standard relational data mechanisms. In one embodiment, these standard relational data mechanisms are stored in a typical relation database, a key-value pair object store, or any other form of data storage that provides key based queries. The storage of the material testing results in the material and supplier verification system allows queries to be performed at any time to drive algorithms that can determine “degree of certainty” or “degree of validation” for any material, lot of material or material supplier. An example of a suitable query is “return all test results from the immutable data store for Supplier X Raw Material 1”.

All materials from a given material supplier can have material testing results validated to a degree of certainty by cross-referencing the unique supplier ID, raw material ID, and related material testing results recorded in the immutable database by locator ID. As used herein, degree of certainty refers to the number of entities, i.e., material suppliers, material requestors, material recipients, e.g., supplement manufacturers, and independent testing laboratories, that verify the material testing results. Each confirming entity is a degree. In one embodiment, additional filters are employed against the recorded material testing results to provide additional parameters on the verification process. For example, the degree of certainty can be calculated for tests performed within the previous 12 months. In one embodiment, the Degree of Certainty calculation is adjusted as needed by industry or regulatory requirements to set time constraints on the recorded transactions, to require a minimum number of passed or confirming tests, or to require that the ratio of passed, confirming, versus failed, non-confirming, tests exceed a predetermined threshold.

In one embodiment, material requestors or material recipients, either internally or through the use of independent or third-party testing laboratories, continue to reconfirm material supplier CoAs periodically as required by the applicable federal agency rule or federal regulation. This ensures material suppliers are being accurately verified within the supply chain network. The frequency at which lots of materials provided by material suppliers are tested by independent testing laboratories and other entities and deemed accurate (verified) on the blockchain network of the material and supplier verification system determines the degree to which a material “supplier is verified” overall or for that ingredient or raw material. The higher the degree of verification, i.e., the higher the frequency of verification, the higher the level of trust that can be associated with any CoA from the material supplier. This frequency can be expressed, for example, at a percentage of initial material testing results that are verified for a given lot of material or material supplier, a percentage of testing entities that verify the material or supplier, and the occurrence of verified testing results for a given lot of material or given material supplier within a given period of time.

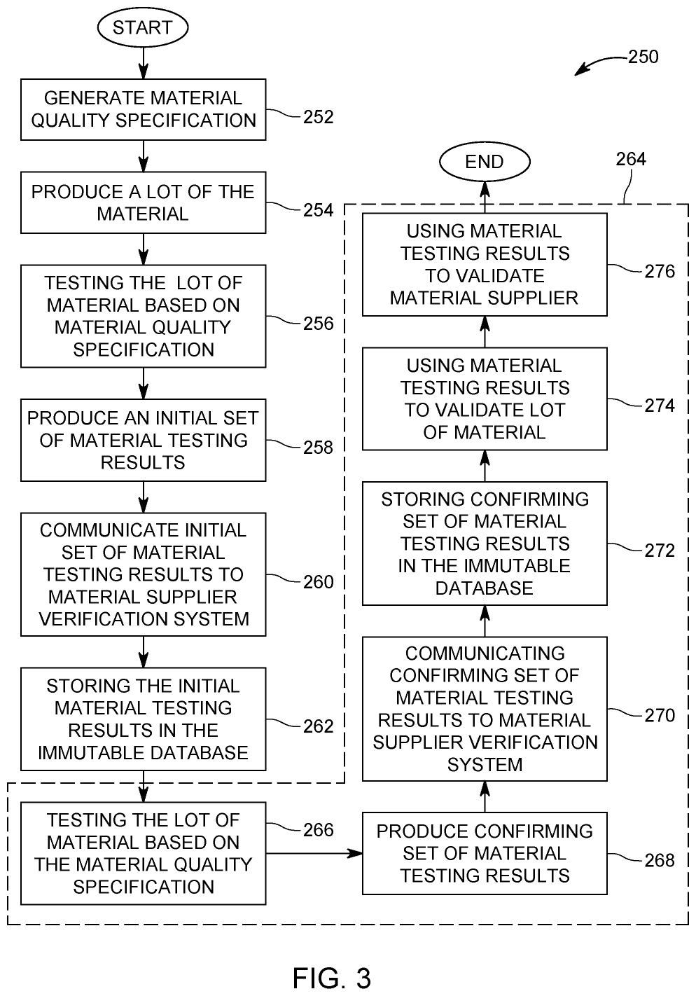

Referring now to FIG. 3, exemplary embodiments are also directed to a method for verifying materials and material suppliers 250. A material quality specification is generated 252 for a given material, for example, a raw material used in the manufacture of other goods such as supplements. In addition to generating a single material quality specification for a single material, multiple material quality specifications can be generated for the single material, or a single material quality specification can be generated for multiple materials. The material quality specification is generated by a requestor. Suitable requestors of the material quality specification include product manufacturers, for example, supplement manufacturers, and material resellers or retailers. Each material quality specification includes, for example, an identification of the material, a quantity of the material, material quality parameters, and an acceptable value or range of values for each material quality parameter. Suitable material quality parameters include, but are not limited to, purity, moisture content, active ingredient percentage, inert ingredients, percentage of inert ingredients, age, and potency. Other material quality parameters include, for example, functionality, strength, structural integrity, concentration, pH, dimensions, weight, and color. In general, the material quality parameters are specific to the type of material and the type of product into which the material is incorporated.

Each material quality specification is communicated to one or more material suppliers, for example, raw material suppliers. Any suitable method known in the art for communicating a request for a material and the desired material quality specifications from a requestor to a supplier can be used. A material supplier produces at least one lot of the material 254 in accordance with the material request and material quality specification. The lot of material is tested or analyzed 256 by a first entity based on the material quality specification. The entity performing the testing can be the material supplier or an independent testing laboratory that performs the testing at the request of the material supplier. Based on the testing of lot of material, an initial set of material testing results is produced 258. In addition, a Certificate of Analysis (CoA) is also produced. In one embodiment, the initial set of material testing results includes an identification of each material quality parameter analyzed or tested, a value for each material quality parameter tested, and a comparison of the tested value to an acceptable value for each material quality parameter as prescribed in the material quality specification.

In one embodiment, the initial set of material testing results is saved or logged, for example, at the material supplier. The initial set of material testing results is communicated to the material supplier verification system 260 and, therefore, to the immutable database that is transparent to historical transactions. In one embodiment, the initial set of material testing results is communicated manually. Alternatively, the initial set of material testing results is communicated automatically in real time as the results are generated. In one embodiment, the material testing results are encrypted before being communicated to the material supplier verification system and then decrypted at the material supplier verification system. In one embodiment, the material testing results are communicated using the data collection tool provided in the material supplier verification system. In one embodiment, the material testing results are communicated to the material supplier verification system along with one or more of a unique key, an identification of the material, an identification of the material supplier, and identification of a material requestor, and an identification of the entity, and an identification of the first entity, i.e., the first material testing entity. This information related to the material testing results can be produced by the material supplier or the first entity. Alternatively, information about the material testing results can be generated by the material verification system. For example, the material supplier verification system, through the data collection tool, can assign a unique key to the material testing results or can recognize the first entity that is uploading the material testing results.

The initial set of material testing results generated by the first entity and analyzing a given lot of material for compliance with a quality specification for the material are then stored in an immutable database 262. The immutable database maintains a trusted historical record of all material testing results for the given lot of material. In one embodiment, the initial set of material testing results, and all material testing results, are stored in the immutable database with transparency to historical changes in material testing results. In one embodiment, the immutable database is a blockchain database. In one embodiment, in addition to storing the initial set of material testing results at least one of a unique unchangeable key for the initial set of material testing results, an identification of the material, an identification of a supplier of the material, an identification of a requestor of the material, and an identification of the first entity are also stored in the immutable database in association with the initial set of material testing results. The first entity is the supplier of the lot of material or an independent testing facility.

In one embodiment, a current data state for the record containing the material testing results is stored in the immutable database along with processing rules governing interaction with material testing results stored in the immutable database to ensure matching of all material testing results for a given lot of material. Suitable processing rules include, but are not limited to, a smart contract. In addition to storing in the immutable database the initial set of material testing results further comprises, a plurality of initial sets of material testing results for a plurality of lots of materials can be stored in the immutable database. Each lot of material supplied by a given material supplier.

In one embodiment, one or more labels are associated with the initial set of material testing results, which can be referred to as a record, within the immutable database. Suitable labels include, but are not limited to, an identification of the lot of material and an identification of the material supplier. In one embodiment, the each label is a permanent unique identification code. In one embodiment, these labels are used for storage, organization and indexing of the records within the immutable database. In one embodiment, the labels are used in searching for records within the immutable database.

Having stored the initial material testing results, the material supplier verification system is used to verifying or validate at least one of the lot of material and the material supplier 264. The lot of material is verified by additional confirming testing from the material requestor, other recipients of the material or an independent testing laboratory. The material supplier is validated based on an evaluation of the testing compliance for the lot of material or for all lots of material provided by the material supplier.

The lot of material is tested or analyzed 266 by at least one additional entity based on the material quality specification. The entity performing the testing can be the material requestor, a recipient of the material or an independent testing laboratory that performs the testing at the request of the material requestor or a recipient of the material. Based on the testing of lot of material, at least one confirming set of material testing results is produced 268. In one embodiment, the confirming set of material testing results includes an identification of each material quality parameter analyzed or tested, a value for each material quality parameter tested, and a comparison of the tested value to an acceptable value for each material quality parameter as prescribed in the material quality specification.

In one embodiment, each confirming set of material testing results is saved or logged, for example, at the material supplier. Each confirming set of material testing results is communicated to the material supplier verification system 270 and, therefore, to the immutable database. In one embodiment, each confirming set of material testing results is communicated manually. Alternatively, each confirming set of material testing results is communicated automatically in real time as the results are generated. In one embodiment, the material testing results are encrypted before being communicated to the material supplier verification system and then decrypted at the material supplier verification system. In one embodiment, the material testing results are communicated using the data collection tool provided in the material supplier verification system. In one embodiment, the material testing results are communicated to the material supplier verification system along with one or more of a unique key, an identification of the material, an identification of the material supplier, and identification of a material requestor, and an identification of the additional entity. This information related to the material testing results can be produced by the additional entity. Alternatively, information about the material testing results can be generated by the material verification system. For example, the material supplier verification system, through the data collection tool, can assign the unique key to the material testing results or can recognize the additional entity that is uploading the material testing results.

At least one confirming set of material testing results generated by at least one additional entity separate from the first entity to confirm the initial set of material testing results is stored in the immutable database in association with the initial set of material testing results 272. Each additional entity is an independent testing facility, a requester of the lot of material or a recipient of the lot of material. In one embodiment, in addition to storing in the immutable database at least one confirming set of material testing results, at least one of a unique unchangeable key for each confirming set of material testing results, an identification of the material, an identification of a supplier of the material, an identification of a requestor of the material, and an identification of each additional entity is also stored in the immutable database. In one embodiment, the immutable database includes a plurality of initial sets of material testing results are stored in the immutable database, for example, for initial sets of material testing results associated with multiple lots of materials from a given material supplier. Therefore, at least one confirming set of material testing results are stored in the immutable database in association with one of the plurality of initial sets of material testing results. Alternatively, multiple confirming sets of material testing results are store din the immutable database in association with multiple initial sets of material testing results.

In one embodiment, a permanent unique identification code is associated with the lot of material, the supplier of the lot of material and each entity generating material testing results for the confirming set of material testing results. In one embodiment, associated permanent unique identification codes are used to index material testing results or to search material testing results.

Having stored the confirming set of material testing results in the immutable database, the initial set of material testing results and all confirming sets of material testing results are used to determine an overall degree of validation for the given lot of material 274. In one embodiment, one degree of validation is assigned to the lot of material for each confirming set of material testing results that confirm the initial set of material testing results. The overall degree of validation is then the sum of each degree of validation assigned to the lot of material. In one embodiment, determining the overall degree of validation for the given lot of material also includes one or more of adjusting the overall degree of validation by only assigning a degree of validation for each confirming set of material testing results associated with testing performed within a prescribed time period, requiring a minimum number of confirming sets of material testing results that confirm the initial set of material testing results, and setting a threshold ratio of confirming sets of material testing results that confirm the initial set of material testing results to confirming set of material testing results that fail to confirm the initial set of material testing results.

In one embodiment, the plurality of initial sets of material testing results and all confirming sets of material testing results are used to determine an overall degree of validation for the given material supplier 276. In one embodiment, the plurality of initial sets of material testing results and all confirming sets of material testing results are used to determine a frequency at which all lots of material provided by the given material supplier are verified by the confirming sets of material testing results.

### EXAMPLES

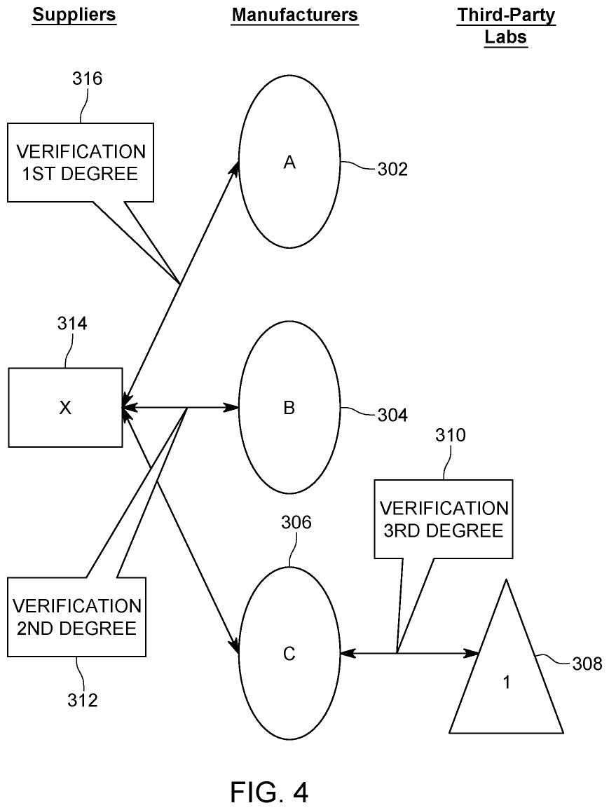

Referring to FIG. 4, an example of the degree of verification for a given supplier from multiple supplement manufacturers is illustrated. Manufacturer A 302, Manufacturer B 304, and Manufacturer C 306 all use Supplier X 314 for Raw Material 1. In addition, Manufacturer A, B, and C all use the same quality specification for Raw Material 1. Supplier X conducts in-house testing to ensure the specifications are met, produces the CoA, communicates the CoA to all three manufacturers and to the supplier verification system. Manufacturers A and B conduct in-house testing to confirm Supplier X's CoA for Raw Material 1, and Manufacturer C uses a third-party testing lab 308 to confirm the CoA. All of these verification testing results are communicated to the supplier verification system. The test from Manufacturer A provides a first degree of verification 316, and the test from Manufacturer B provides a second degree of verification 312. The test from the third-party testing laboratory 308 at the request of Manufacturer C provides a third degree of verification. Any interested party accessing or searching the data in the supplier verification system will be provided with data showing that Supplier X is verified to the third degree for Raw Material 1.

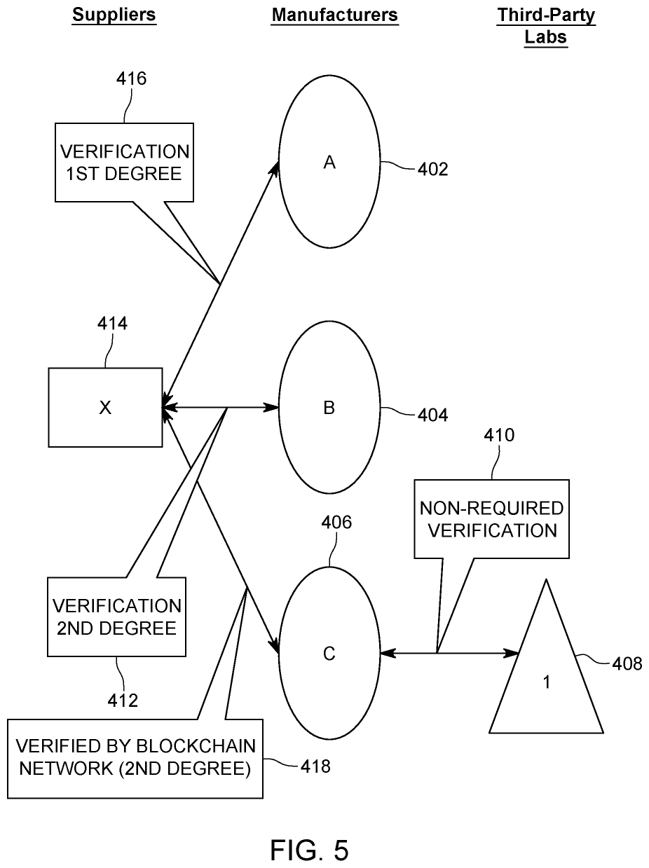

Referring to FIG. 5, another example of the degree of verification for a given supplier from multiple supplement manufacturers is illustrated. Manufacturer A 402, Manufacturer B 404, and Manufacturer C 406 all use Supplier X 414 for Raw Material 1. Again, Manufacturer A, B, and C all use the same quality specification for Raw Material 1. Supplier X conducts in-house testing to ensure the specifications are met, produces the CoA, communicates the CoA to all three manufacturers and to the supplier verification system. Manufacturers A and B conduct in-house testing to confirm Supplier X's CoA for Raw Material 1. These verification testing results are communicated to the supplier verification system. The test from Manufacturer A provides a first degree of verification 416, and the test from Manufacturer B provides a second degree of verification 412. Manufacturer C, before requesting a verification test from the third-party testing laboratory 408 accesses and searches the data in the supplier verification system regarding Supplier X and Raw Material 1. The lab results from Manufacturers A and B are confirmed on an immutable ledger, and Manufacturer C is shown that Supplier X is verified to a second degree 418. This second degree verification eliminates the need for Manufacturer C to verify Supplier X 418 and to use the third-party lab to confirm the CoA.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention are capable of being implemented in conjunction with any other type of computing environment now known or later developed including distributed or cloud computing systems. Cloud computing is a model of service delivery for enabling convenient, on-demand network access to a shared pool of configurable computing resources, e.g., networks, network bandwidth, servers, processing, memory, storage, applications, virtual machines, and services, that can be rapidly provisioned and released with minimal management effort or interaction with a provider of the service.

Exemplary embodiments can be provided using different service models including Software as a Service (SaaS), Platform as a Service (PaaS) and Infrastructure as a Service (IaaS). Software as a service provides the capability to the consumer to use the provider's applications running on a cloud infrastructure. The applications are accessible from various client devices through a thin client interface such as a web browser, e.g., web-based e-mail. Platform as a service provides the capability to the consumer to deploy onto the cloud infrastructure consumer-created or acquired applications created using programming languages and tools supported by the provider. Infrastructure as a service provides the capability to the consumer to provision processing, storage, networks, and other fundamental computing resources where the consumer is able to deploy and run arbitrary software, which can include operating systems and applications.

The foregoing written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for verifying materials and material suppliers, the method comprising:
storing in an immutable database an initial set of material testing results generated by a first entity and analyzing a given lot of material for compliance with a quality specification for the material;
storing in the immutable database in association with the initial set of material testing results at least one confirming set of material testing results generated by at least one additional entity separate from the first entity to confirm the initial set of material testing results; and
using the initial set of material testing results and all confirming sets of material testing results to determine an overall degree of validation for the given lot of material;
wherein the immutable database maintains a trusted historical record of all material testing results for the given lot of material.

2. The method of claim 1, wherein storing in the immutable database comprises storing in the immutable database with transparency to historical changes in material testing results.

3. The method of claim 1, wherein the immutable database comprises a blockchain database.

4. The method of claim 1, wherein storing in the immutable database the initial set of material testing results further comprises storing at least one of a unique unchangeable key for the initial set of material testing results, an identification of the material, an identification of a supplier of the material, an identification of a requestor of the material, and an identification of the first entity.

5. The method of claim 1, wherein storing in the immutable database at least one confirming set of material testing results comprises storing at least one of a unique unchangeable key for each confirming set of material testing results, an identification of the material, an identification of a supplier of the material, an identification of a requestor of the material, and an identification of each additional entity.

6. The method of claim 1, wherein the method further comprises storing in the immutable database in combination with a current data state processing rules governing interaction with material testing results stored in the immutable database to ensure matching of all material testing results for a given lot of material.

7. The method of claim 6, wherein the data processing rules comprise a smart contract.

8. The method of claim 1, wherein the method further comprises associating a permanent unique identification code with the lot of material, a supplier of the lot of material and each entity generating material testing results; and
using the associated permanent unique identification codes to index material testing results or to search material testing results.

9. The method of claim 1, wherein:
the first entity comprises a supplier of the lot of material or an independent testing facility; and
each additional entity comprises an independent testing facility, a requester of the lot of material or a recipient of the lot of material.

10. The method of claim 1, wherein using the initial set of material testing results and all confirming sets of material testing results to determine an overall degree of validation for the given lot of material comprises assigning one degree of validation to the lot of material for each confirming set of material testing results that confirm the initial set of material testing results.

11. The method of claim 10, wherein using the initial set of material testing results and all confirming sets of material testing results to determine an overall degree of validation for the given lot of material further comprises adjusting the overall degree of validation by only assigning a degree of validation for each confirming set of material testing results associated with testing performed within a prescribed time period, requiring a minimum number of confirming sets of material testing results that confirm the initial set of material testing results, setting a threshold ratio of confirming sets of material testing results that confirm the initial set of material testing results to confirming set of material testing results that fail to confirm the initial set of material testing results, or combinations thereof.

12. The method of claim 1, wherein:
storing in the immutable database the initial set of material testing results further comprises storing in the immutable database a plurality of initial sets of material testing results for a plurality of lots of materials, each lot of material supplied by a given material supplier;
storing in the immutable database in association with the initial set of material testing results further comprises storing in the immutable database in association with one of the plurality of initial sets of material testing results the at least one confirming set of material testing results; and
the method further comprises using the plurality of initial sets of material testing results and all confirming sets of material testing results to determine an overall degree of validation for the given material supplier.

13. The method of claim 12, wherein using the plurality of initial sets of material testing results and all confirming sets of material testing results to determine an overall degree of validation for the given material supplier comprises using the plurality of initial sets of material testing results and all confirming sets of material testing results to determine a frequency at which all lots of material provided by the given material supplier are verified by the confirming sets of material testing results.

14. A material and supplier verification system comprising:
an immutable database comprising:
an initial set of material testing results generated by a first entity and analyzing a given lot of material for compliance with a quality specification for the material; and
at least one confirming set of material testing results generated by at least one additional entity separated from the first entity to confirm the initial set of material testing results, each confirming set of material testing results associated within the immutable database with the initial set of material testing results, and the immutable database maintaining a trusted historical record of all material testing results for the given lot of material; and
a computing system in communication with the immutable database, the computing system executing a validation module that uses the initial set of material testing results and all confirming sets of material testing results to determine an overall degree of validation for the given lot of material.

15. The material and supplier verification system of claim 14, wherein the immutable database comprises a blockchain database.

16. The material and supplier verification system of claim 14, wherein the immutable database further comprises at least one of a unique unchangeable key for the initial set of material testing results, an identification of the material, an identification of a supplier of the material, an identification of a requestor of the material, an identification of the first entity, and an identification of each additional entity.

17. The material and supplier verification system of claim 14, wherein verification module assigns one degree of validation to the lot of material for each confirming set of material testing results that confirm the initial set of material testing results.

18. The material and supplier verification system of claim 17, wherein the verification module adjusts the overall degree of validation by only assigning a degree of validation for each confirming set of material testing results associated with testing performed within a prescribed time period, requiring a minimum number of confirming sets of material testing results that confirm the initial set of material testing results, setting a threshold ratio of confirming sets of material testing results that confirm the initial set of material testing results to confirming set of material testing results that fail to confirm the initial set of material testing results, or combinations thereof.

19. The material and supplier verification system of claim 14 wherein:
the immutable database comprises a plurality of initial sets of material testing results for a plurality of lots of materials, each lot of material supplied by a given material supplier;
the at least one confirming set of material testing results associated with each one of the plurality of initial sets of material testing results; and
the verification module uses the plurality of initial sets of material testing results and all confirming sets of material testing results to determine an overall degree of validation for the given material supplier.

20. The material and supplier verification system of claim 19, wherein the verification module determines a frequency at which all lots of material provided by the given material supplier are verified by confirming sets of material testing results.
